(19) United States
(12) Patent Application Publication
(10) Pub. No.: US 2012/0009323 A1
(43) Pub. Date: Jan. 12, 2012

(54) STABLIZED WHOLE GRAIN FLOUR

(75) Inventors: Ansui Xu, Carmel, IN (US); Michael Vanhouten, Carmel, IN (US)

(73) Assignee: Cargill, Incorporated, Wayzata, MN (US)

(21) Appl. No.: 13/240,538

(22) Filed: Sep. 22, 2011

Related U.S. Application Data
(63) Continuation of application No. 11/915,311, filed on Jul. 8, 2008.

(51) Int. Cl. A21D 6/00; A23L 1/172

(52) U.S. Cl. 426/622

(57) ABSTRACT

Stabilized whole grain corn flour having extended storage stability and modified functional properties, such as improved processing tolerance, improved dough properties and enhanced corn flavors, is described, as are methods of making such stabilized whole grain corn flour.

### CROSS REFERENCE TO RELATED APPLICATION

This application is a continuation of U.S. application Ser. No. 11/915,311 filed Nov. 21, 2007, which claims the benefit of International Application No. PCT/US2006/020287 filed May 24, 2006, and of U.S. Application No. 60/683,797 filed May 24, 2005, all incorporated herein by reference in their entirety.

### FIELD OF THE INVENTION

The present invention is directed to stabilized whole grain products and methods of making the same.

### BACKGROUND

Cereal grain flours including whole grain flours are typically further processed into different forms before being consumed as foods. In those processes, cereal grain flours are typically mixed with water and cooked by baking, extrusion, steam-heating or boiling. One important aspect of cereal grain flours is their ability to tolerate further processing. Another important aspect of cereal grain flours is their dough properties. One important way to improve dough properties is through pre-gelatinization. A cereal grain flour with improved processing tolerance or dough properties can reduce the use level of other ingredients such as modified food starches, gums, surfactants and emulsifiers, improve food attributes such as texture and bulk density, and expand the ranges of processing conditions such as extrusion rate, enhancing production flexibility and increasing production efficiency.

Whole cereal grains, i.e., individual kernels of grains, exhibit extended stability. Upon milling to a whole grain flour, however, the raw whole grain flour typically exhibits rapid deterioration. This rapid deterioration is due in large part to enzymatic activity, especially that which is associated with the lipid component. Partly for this reason, typical milling procedures mill the cereal grain so as to form separate streams of the bran, germ, and starchy fractions, since the lipid component is associated with the grim fraction. The raw starch cereal flour fraction exhibits extended stability. On the other hand, whole grain flours and products prepared therefrom are desirable due in large part to their taste and nutritional benefits. Present consumer interest is great in products that provide the enhanced nutritional benefits and taste attributes of whole grain flours.

One method for stabilizing whole cereal grains is disclosed in U.S. Pat. No. 4,737,371. The method involves heat-treating either the intact grain or the separated germ fraction at a moisture content of about 13-17% and a temperature in the range of about 95°-100° C. U.S. Pat. No. 4,737,371 reports that the physical nature of the heat-treated grain remains virtually unaltered as evidenced by birefringence, water absorption index, water solubility index, density, and initial cold visco-amylograph viscosity. In addition, U.S. Pat. No. 4,737,371 reports that the functional properties of the heat-treated grains are unchanged.

### SUMMARY OF THE INVENTION

The present invention is directed to stabilized whole grain corn flour that have extended storage stability and has modified functional properties that include improved processing tolerance, improved dough properties and enhanced corn flavors, and methods of making the stabilized whole grain corn flour. According to one aspect, a stabilized whole grain corn flour is substantially free of catalase activity and has a Rapid Viscosity Analyzer peak viscosity of less than about 600 cps (e.g., less than about 500, 400, 300, 200, or 100 cps) at about 35% dry basis while mixed at about 50° C., and a Rapid Viscosity Analyzer peak viscosity of less than about 4000 cps (e.g., less than about 3500, 3000, 2500, 2000, 1500, 1000, or 500 cps) while heated to and held at about 95° C. at about 12.5% dry basis. Typically, stabilized whole grain corn flour of the present invention has an oil content of at least about 3% (w/w) and a dietary fiber of at least about 7% (w/w).

According to another aspect, a method is provided for producing stabilized whole grain corn flour having modified functionality and flavor while maintaining extended storage stability. The method comprises treating whole corn kernels or separated corn germ with direct heat, such as direct steam or forced air, at temperatures of about 230-280° F. A key advantage of the process is that it imparts modifications to functional and flavor properties of the flour while making it stabilized for extended storage. Such modifications include inhibited viscosity that increases the processing tolerance of the corn product, improved dough properties and enhanced corn flavor that include sweet corn flavor, popcorn flavor, buttery flavor and toasted corn flavor. Another advantage of the present invention is that direct steam and heated air is more efficient in heating time and energy input requirement.

Increased processing tolerance can be quantified, for example, by a Rapid Viscosity Analyzer peak viscosity of less than about 600 cps (e.g., less than about 500, 400, 300, 200, or 100 cps) at about 35% dry basis while mixed at about 50° C., and a Rapid Viscosity Analyzer peak viscosity of less than about 4000 cps (e.g., less than about 3500, 3000, 2500, 2000, 1500, 1000, or 500 cps) while heated to and held at about 95° C. at about 12.5% dry basis. Improved dough properties are characterized, for example, by the ability of the flour to form a cohesive dough or batter with cold water.

Stabilized whole grain corn flour can be prepared by heating whole kernel corn with forced heated air to bring the corn temperature to a range of about 230-280° F. (e.g., from about 240-270° F.) for about 5-25 minutes (e.g., about 10-20 minutes), and grinding the heat-treated corn by hammer mill or attrition mill or another suitable mill to desired granulation profile.

In another aspect, stabilized whole grain corn flour can be prepared by heating whole kernel corn with direct steam pressurized to about 60-120 psi to a temperature of about 230-280° F. (e.g., about 230-250° F.) for about 2-15 minutes (e.g., about 4-8 minutes), keeping the corn in the steam jacketed conveyor at about 200-230° F. for about 10-30 minutes (e.g., about 15-25 minutes), and grinding the heat-treated corn by hammer mill or attrition mill or another suitable mill to desired granulation profile.

In still another aspect, stabilized whole grain corn flour can be prepared by separating corn germ from corn kernels with a degerminator; heating corn germ with direct steam pressurized to about 60-120 psi to a temperature of about 230-280° F. (e.g., about 230-250° F.) for about 2-15 minutes (e.g., about 4-8 minutes); keeping the heated corn germ in the steam jacketed conveyor at about 200-230° F. for about 10-30 minutes (e.g., about 15-25 minutes); grinding the heat-treated corn germ by hammer mill or attrition mill or another suitable mill to desired granulation profile; and recombining the heat-treated germ with the rest of the corn kernels that has been separately ground to the desired granulations.

In still another aspect, stabilized whole grain corn flour can be prepared by separating corn germ from corn kernels with a degerminator; heating corn germ with direct steam pressurized to about 60-120 psi to a temperature of about 230-280° F. (about 230-250° F.) for about 2-15 minutes (about 4-8 minutes); keeping the heated corn germ in the steam jacketed conveyor at about 200-230° F. for about 10-30 minutes (e.g., about 15-25 minutes); recombining the heat-treated germ with the rest of the corn kernels; and grinding the recombined constituents by hammer mill, attrition mill, or other suitable mill to desired granulation profile.

In yet another aspect, stabilized whole grain corn flour can be prepared by separating corn germ from corn kernels with a degerminator; heating corn germ with direct steam pressurized to about 60-120 psi to a temperature of about 230-280° F. (e.g., about 230-250° F.) for about 2-15 minutes (e.g., about 4-8 minutes); keeping the heated corn germ in the steam jacketed conveyor at about 200-230° F. for about 10-30 minutes (about 15-25 minutes); recombining the heat-treated germ with the rest of the corn kernels that have been ground to desired granulation profile; cooking the recombined constituents with added water and direct steam to modify the viscosity profile; drying the cooked flour to a moisture of about 8-15%; and grinding the product to final desired granulations.

A pre-gelatinized whole grain corn flour can be obtained by further processing the heat-treated product (e.g., the stabilized whole grain corn flour or a precursor thereof). Further processing can include, for example, mixing the product with about 20-35% water for about 1-10 minutes; cooking the product in a single-screw extruder jacketed with steam; drying the extruded product; and grinding the product to the desired granulations with a hammer mill, attrition mill, or other suitable mill.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the drawings and detailed description, and from the claims.

### BRIEF DESCRIPTION OF THE DRAWINGS

FIGS. 1A and 1B schematically illustrate a representative apparatus that can be used for preparing a stabilized whole grain corn flour in accordance with the present invention.

FIG. 2 is a graph showing the free fatty acid levels in the different flours after accelerated storage conditions.

FIG. 3 is a graph showing the hexanal levels in the different flours after accelerated storage conditions.

FIG. 4 is a graph showing the peroxide levels in the different flours after accelerated storage conditions.

FIG. 5 is a graph showing the effect of pregel level on cereal strength.

FIG. 6 is a graph showing the effect of fiber granulations on cereal strength.

FIG. 7 is a graph showing the effect of fiber type on cereal strength.

Like reference symbols in the various drawings indicate like elements.

### DETAILED DESCRIPTION OF THE INVENTION

Cereal foods have long been a main staple for man. Refined cereal grain flours are mainly composed of endosperm of the cereal grain that is lower in oil and total dietary fiber, whereas whole grain flours contain all the components in the original whole grain, including endosperm, germ and bran, as well as tipcap in the case of corn, in substantially the same proportion as in the original grain. Because germ is high in oil content and bran is high in total dietary fiber content, whole grain flours generally have higher oil and total dietary fiber contents than refined flours. By way of example only, whole grain contains approximately 83% endosperm, approximately 11% germ, and approximately 5% bran.

The present disclosure provides for a stabilized whole grain corn flour with unique characteristics and methods of making such stabilized whole grain flour products. The stabilized whole grain flour of the present invention can be made by treating the grain with direct heat for a time and at a temperature sufficient to deactivate enzymes, which extends the storage stability, and to change the functionality of the resultant flour (e.g., to significantly reduce the viscosity (e.g., warm and hot viscosity) of the resulting whole grain flour). The grain also or alternatively can be treated with indirect heat to further affect the process.

The heat-treated whole grain flour is free or substantially free of catalase and/or peroxidase activity. Catalase is a type of enzyme that is involved in converting hydrogen peroxide into water and oxygen in conjunction with peroxidase. Since catalase and peroxidase are known to tolerate higher temperature than other enzymes in cereal grains, it is understood by those of skill in the art that the absence of catalase and/or peroxidase activity in heat-treated plant materials is an indication of the complete deactivation of all enzymes therein.

A product is substantially free of catalase or peroxidase activity, for example, if enzymatic activity is undetectable or near the detection limit associated with a method. Catalase activity can be determined according to the method described in USDA Announcement WSM7 (Aug. 3, 2001). Catalase activity also can be measured using the floating disc method (see, for example, Gagnon et al., 1959, Anal. Chem., 31:144-6) and/or the Clark-type O₂ monitor (see, for example, Roth & Jensen, 1967, Biochim. Biophys. Acta, 139:171). See, also, Nir et al., 1986, Plant Physiol., 81:1140-2. Peroxidase can be measured using, for example, the method disclosed in the American Association of Cereal Chemists (AACC) Method 22-80, Qualitative Test for Peroxidase in Oat Products.

Direct heat as used herein refers to methods of heating the corn where the primary healing medium is in direct contact with individual corn kernels or directly mixed with (e.g., ground) corn components. Examples of direct heat include live steam injected into corn or corn components and hot air forced through layers of corn or corn components. Indirect heat as used herein refers to methods of heating the corn or corn components where the heat is transferred from the primary heating medium to the corn or corn components (e.g., germ) through a barrier such as the metal wall of a container housing the corn or corn components.

One example of a heating device that can be used to deactivate enzymes in whole grain corn to prepare a whole grain corn flour is a forced air oven with a metal conveying belt that has holes of about 0.2-1.0 mm in diameter. Air that has been heated to a temperature of about 270-350° F. using a heat exchanger is forced through a layer of whole kernel corn to provide direct heat to corn kernels. The corn temperature is brought to about 230-280° F. for about 5-25 minutes. The heated corn is then cooled and ground on a hammer mill, attrition mill, or other suitable mill to the desired granulations. A heating device of this nature is particularly suitable for making stabilized whole corn products with toasted or buttery corn flavor and with high processing tolerance.

Another example of a heating device is a heating chamber fitted with an auger that propels the corn product and the chamber is fitted with live steam inlets along the length of the auger. When whole kernel corn is conveyed in the chamber, live steam pressurized to about 60-120 psi is introduced to the corn to heat the corn to a temperature of about 230-280° F. for about 2-15 minutes. Following heat treatment using this device, the heated corn is conveyed into a screw conveyor that has a jacket that is fitted with steam which provides indirect heat to keep the temperature of corn at about 200-230° F. for about 10-30 minutes. The treated corn is then ground on a hammer mill, attrition mill, or another suitable mill to the desired granulations. Devices of this nature are particularly suitable for making stabilized whole corn products with sweet or popcorn flavor corn flavor and with low to moderate processing tolerance.

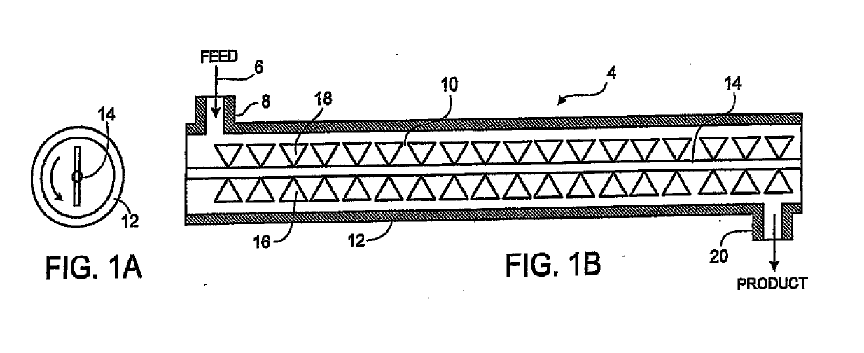

In one specific example, a mixer-type cooker can be used to heat treat the corn. A representative mixer-type cooker is shown in FIGS. 1A and 1B. This mixer-type cooker has an elongated heating device which has a heat jacket surrounding a channel through which the corn is conveyed. The corn is moved forward down the cooker by means of paddles on a hollow rotor in the device. The rotor is connected to a steam source to transmit steam to the paddles, which are hollow and are open to receive steam from the rotor. Steam enters the rotor and is conveyed into the paddles that have one or more holes from which the steam can be injected into the corn. The paddles uniformly distribute the steam into the corn. Indirect heat can be applied from the jacket of the device. The direct heat brings the corn to temperature while the indirect heat keeps the cooker and the corn at an elevated temperature. Heating conditions are controlled through selection of a specific length for the device, the number of open steam holes in the paddles, the amount of indirect heat being applied, and the rate that the corn is conveyed through the cooker.

Referring to FIGS. 1A and 1B for more detail, the corn is fed into an elongated heating device 4 shown in FIG. 1B. The corn is fed into the heating device feed aperture 8 into channel 10. The corn is conveyed down the channel 10 in the ‘y’ direction. Channel 10 is surrounded by a steam jacket 12 through which steam can be circulated. A hollow rod 14 extends longitudinally down the center of the channel. A plurality of paddles 16 are mounted on the rod 14 down its longitudinal length. The rod 14 is rotated and the paddles are angled such that as the rod rotates the paddles, mixes the corn and pushes the corn down channel 10. The paddles have openings 18 which extend through the paddles to the hollow center of rod 14. These openings are to transmit steam going through the rod and paddles so that the steam may be injected into the corn being transmitted down channel 10. As the rod rotates, the paddles push the corn down the conduit to exit aperture 20, through which the corn flows. The openings in the paddles may be opened or closed to control steam injection into the corn being transmitted down the channel. Additional indirect heating of the corn and the cooking channel can be done by using indirect heat from the jacket of the device. Enough steam can be injected to bring the corn to a temperature of at least about 230° F.

One representative device which can be used to heat-treat corn as described herein, is available as a Solidaire Model RCS 8-4 from the Hosokawa Bepex Corporation (Minneapolis, Minn.). This device is particularly suitable for making stabilized whole grain corn flour with sweet or popcorn flavor and with low to moderate processing tolerance. This device is also suitable for further modifying functional properties of stabilized whole grain corn flour to achieve the desired dough properties.

In some embodiments, the germ can be separated from whole corn kernel using, for example, a degerminator. Degermination can be performed using any standard method. See, for example, Duensing at al., 2003, Corn: Chemistry and Technology, 2^{rd} Ed., White and Johnson, Eds., American Association of Cereal Chemists, St. Paul, Minn., Ch. 11, pp. 407-47.

The separated germ can be heat-treated (e.g., using direct heat (e.g., live steam) with or without indirect heat) as described above for corn. For example, live steam pressurized to about 60-120 psi can be introduced into the germ to heat the germ to a temperature of about 230-280° F. for about 2-15 minutes. Following the direct-heat treatment, the heated-treated germ can be conveyed into a screw conveyor that has a jacket fitted with steam that provides indirect heat to keep the temperature of germ at about 200-230° F. for about 10-30 minutes. These treatments with direct and indirect heat typically result in stabilized germ that has popcorn or buttery aroma and flavor.

In addition, the bran can be separated from other corn components using, for example, an aspirator. Once separated, the bran can be treated as described in U.S. Pat. No. 6,383,547, which is incorporated by reference herein. U.S. Pat. No. 6,383,547 describes the heat treatment and subsequent grinding of bran to, for example, a granulation of at least 80% through 60M (i.e., at least 80% of the total weight through a 60 mesh screen). Similarly, the endosperm can be ground, for example, to a granulation of at least 90% through 60M.

On one embodiment, the heat-treated and ground germ can be recombined with the heat-treated and ground bran and with the ground endosperm. Alternatively, the heat-treated germ and heat-treated bran can be recombined with the endosperm and ground together to the desired granulation size. The germ can be recombined with the remaining grain components in substantially the same proportion as exists in the whole grain corn.

After recombining the components and grinding the components, if done after recombining, the whole grain mixture is cooked with, for example, water and steam, to the desired viscosity. See, for example, U.S. Pat. No. 6,068,873, which is incorporated herein by reference. The mixture can be dried to, for example, a moisture content of about 11.5% to about 13.5%. See, for example, U.S. Pat. No. 6,068,873. The dried product then is ground to the desired granulation size (e.g., to a granulation of at least 75% through 60M).

The stabilized whole grain corn flour described herein can be used in a variety of food products to improve the total dietary fiber content while maintaining or improving the taste of such food products. In addition, the stabilized whole grain corn flour does not possess the rancidity issues exhibited by current whole grain flour, and is able to impart that stability to a food product containing the stabilized whole grain flours described herein.

A pregelatinized whole grain flour can be made by performing the steps as described above (e.g., cleaning, heat-treating, degermination, grinding of the germ and, optionally, the bran, and recombining), and then cooking and extruding the recombined mixture. The conditions for cooking can include those described herein for whole corn, and extruding can be performed, for example, on a single-screw extruder at an exit temperature of 280-310° F. The extruded product can be dried, for example, to a moisture content of 12% and ground, for example, to a granulation of at least 75% through 60M.

The viscosity of the stabilized whole grain corn flour is reported herein in centipoise (cps) units measured using a Rapid Viscosity Analyzer (RVA 4; Newport Scientific; Warriewood, Australia). Viscosity can also or alternatively be measured and/or reported in rapid viscosity units (RVU). One RVU is generally considered to be equivalent to 12 centipoise units.

The stabilized whole grain corn flour disclosed herein typically has a RVA peak viscosity of less than about 600 cps at about 35% dry basis (of a 10 g sample) while mixed at about 50° C. for at least about 12.5 min. The RVA breakdown viscosity under the 35%, 50° C. conditions typically is less than about 300 cps. The stabilized whole corn product described herein generally has a RVA peak viscosity of less than about 4000 cps while heated to and held at about 95° C. at about 12.5% dry basis (of a 4 g sample; See Standard 1, 2002 Software Manual Thermocline for Windows, Version 2.3; Newport Scientific; Warriewood, Australia). The RVA breakdown viscosity under the 12.5%, 95° C. conditions typically is less than about 2000 cps.

In addition to the characteristics (e.g., fat content, total dietary fiber content) described above for the stabilized whole grain corn flour, pregelatinized whole grain flour generally has the following characteristics: (a) the majority (e.g., 90-100%) of the starch granules in the flour lose their birefringence as can be measured using a microscope with polarized light and/or a differential scanning calorimeter; (b) the viscosity of the flour when mixed in cold water (e.g., 0 to 45° C., but typically at room temperature) at any solid content is significantly higher than that of non-pregelatinized whole grain flours, as measured using any of a number of viscosity measuring device (e.g., a Brookfield Viscometer, a Rapid Visco-Analyser, a Bostwick Consistometer, a Brabender Visco-Amylograph); and (c) the cohesion of the dough using pregelatinized whole grain corn flour alone or with other flours made either from corn or other grains (e.g., wheat, rice, barley or oat) is stronger as determined manually (e.g., by handling the dough) or instrumentally using, for example, a texture analyzer. The pregelatinized whole grain flour generally has an RVA value of over 20,000 cps at 50° C. at 35% dry basis.

A stabilized whole grain corn flour disclosed herein can be used in essentially any food product that contains a non-whole grain corn flour or meal. For example, cereals, snacks, tortilla chips, corn chips, tortillas, taco shells, bread, cakes, crackers, muffins, and batters and breedings can include a stabilized whole grain corn flour as described herein. A pregelatinized whole grain flour as described herein can be used in any of the above-indicated food products to impart cold viscosity and dough cohesion, improve processing properties and enhance final product attributes such as product texture and appearance. It is understood by those of skill in the art that the desirable taste, strength, and/or texture of a food product (e.g., cereal) varies from product to product, and the amounts of whole grain flours (pregel or not) and/or the level of total dietary fiber (e.g., by adding corn bran) can be modified accordingly to obtain the desired feature(s) in the particular food product.

In accordance with the present invention, there may be employed conventional chemistry, biochemistry methods within the skill of the art. Such methods are explained fully in the literature. The invention will be further described in the following examples, which do not limit the scope of the invention described in the claims.

### EXAMPLES

### Example 1

### Stabilized Whole Grain Corn Flour, Sample A

In this example, No. 2 yellow dented corn was heated by forced hot air while being conveyed in a layer of about 0.5-4 inches thickness on a meshed metal belt in an oven. The forced hot air moved perpendicular to the conveying direction through the meshed belt and the layer of the corn, being in direct contact of individual kernels of corn. The temperature of the corn kernels reached 250-260° F. and the dwell time was 20 minutes. The corn was then cooled and hammer milled to a granulation of trace on 20M and 63.3% through 60M. The product was negative for catalase activity. The product had an oil content of 4.50% and a total dietary fiber content of 9.9%. The product bad toasted corn flavor.

### Example 2

### Stabilized Whole Grain Corn Flour, Sample B

In this example, No. 2 yellow dented corn was heated by live steam of 80-120 psi through steam injection inlets in a heating chamber fitted with an auger that propels the corn. The temperature of the corn kernels reached above 300° F. upon contact with the live steam but the bulk of the corn reached a temperature of 240° F. The dwell time was 5-7 minutes. The corn was then fed into a screw conveyor that is steam jacketed to maintain the temperature inside the conveyor. The temperature of corn was maintained at 200-230° F. and the dwell time was 20 minutes. The product was then hammer milled to a granulation of trace on 20 M and 74.5% through 60M. The product was negative for catalase activity. The product had an oil content of 3.52% and a total dietary fiber content of 8.9%. The product had a flavor note characteristic of sweet corn and popcorn.

### Example 3

### Stabilized Whole Grain Corn Flour, Sample C

In this example, germ was separated from No. 2 yellow dented corn using a degerminator and an aspirator. The separated germ was heated by live steam at 80-120 psi through steam injection inlets in a heating chamber fitted with an auger that propels the germ. The temperature of the germ reached about 300° F. upon contact with the live steam but the bulk of the germ reached a temperature of 235° F. The dwell time was 5-7 minutes. The germ was then fed into a screw conveyor that is steam jacketed to maintain the temperature inside the conveyor. The temperature of the corn was maintained at 200-230° F. and the dwell time was 18 minutes. The treated germ was negative in catalase activity and had a popcorn and buttery flavor note.

The rest of the corn components including endosperm, bran and tip cap were ground to a granulation of 99% through 60M using an attrition mill. The ground flour was recombined with the treated germ in a proportion similar to that found in the original corn. To the recombined mixture, water was added to bring the moisture content to about 28-30% and the mixture was further cooked in a mixer type cooker with direct steam and steam jacket for 1 minute at 195° F. The mixture was then dried to a moisture of about 11% and ground to a granulation of 81.6% through 60M. Alternatively, lime can be used (e.g., 0.01 to 0.2%) during the cooking process to make a whole grain masa flour.

The cooked product was a whole grain corn flour. The product was negative for catalase activity. The product bad an oil content of 4.4% and a total dietary fiber content of 9.3%. The product bad a flavor note that is characteristic of corn flour.

### Example 4

### Characteristics of Stabilized Whole Grain Corn Flour

Table 1 shows various physical properties for the flours of Examples 1-3 and for untreated yellow corn flour, including the 35% dry solid RVA (Rapid Viscosity Analyzer) peak, final and breakdown viscosity values while maintained at 50° C. Also included are the 12.5% RVA peak, valley and breakdown viscosity values while heated to and maintained at 90° C. The significantly lower breakdown viscosity values for Examples 1-3 (for both 35% and 12.5% RVA) indicated improved processing tolerance of the flour. Table 1 also shows the heat of gelatinization and the gelatinization temperature range for each sample. The increased gelatinization temperature ranges of the treated flours (Examples 1-3) indicate a moderate level of molecular reorganization of the starch, which helps the flour in processing tolerance. A decrease in gelatinization heat (Examples 2-3) indicate a moderate level of starch damage of less perfect starch crystals, which provides a balanced processing and water absorptions properties for this flour. The flours readily make a cohesive dough that can be conveniently processed into different forms of foods.

TABLE 1

| | | | | Untreated |
|---|---|---|---|---|
| | Sample A | Sample B | Sample C | Yellow Flour |
| 35% RVA (cps) | | | | |
| peak | 88 | 465 | 235 | 1256 |
| final | 80 | 461 | 200 | 812 |
| breakdown | 8 | 4 | 35 | 444 |
| 12.5% RVA (cps) | | | | |
| peak | 1329 | 3880 | 3039 | 5293 |
| final | 1161 | 2282 | 1858 | 2673 |
| breakdown | 186 | 1598 | 1181 | 2620 |
| Heat of Gelat- | 10.1 | 7.4 | 3.0 | 8.6 |
| inization (J/g) | | | | |
| Gelatinization | 71.9-90.4 | 72.7-87.0 | 75.7-87.9 | 68.3-86.4 |
| Temp. (° C.) | | | | |

### Example 5

### Procedure for Making Stabilized Whole Grain Corn Flour

Yellow corn (#2 dented) was separated into its three main components (endosperm, bran and germ) by dry milling techniques. Once separated, the bran was ground to a granulation of at least 80% through 60M on an attrition mill or a micropulverizer. The endosperm (with minor bran and germ contamination) was ground to a granulation of at least 90% through 60M to flour using an attrition mill. Alternatively, the bran can be treated (e.g., tempered, cooked and ground) as disclosed U.S. Pat. No. 6,383,547 and be recombined proportionally with the rest of the streams at any of the following process steps (e.g., after cooking, drying and grinding the rest of the streams).

The separated germ was heated in a rotary dryer to about 150-180° F. for about 10 min and then cooled to about 10° F. above ambient temperature. Alternatively, the separated germ can be heated in a steam-jacketed chamber for about 5 min at a temperature of about 200-230° F. The target moisture of the germ was about 8-10%. The endosperm (flour) and bran, ground separately or together, and the treated germ were recombined at approximately the same proportion as in the corn.

Water was added to the mixture of flour and germ to achieve a moisture level about 28-30%. The actual level of water addition is related to the viscosity of the product, with a higher water level leading to a higher viscosity. As the mixture was transported through a steam-jacketed cooker, steam was injected into the cooker. The dwell time in the cooker was about 0.5-2 min, and the exit temperature was about 198-202° F. The temperature is also a factor that influences the viscosity. Alternatively, cooking of the mixture can be done in a Solidaire cooker as described in U.S. Pat. No. 6,068,873.

The cooked product was dried in a rotary tumbler dryer at a temperature of about 150-180° F. to a moisture of 11.5-13.5%. It took approximately 20 min to dry the product. The product was cooled to about 10° F. above ambient temperature in another rotary tumbler. Alternatively, drying can be done on a Micron dryer as described in U.S. Pat. No. 6,068,873. The dried product then is ground on a hammer-mill to a final granulation of about 75% through 60M.

### Example 6

### Procedure for Making Pregelatinized Whole Grain Corn Flour

Yellow corn (#2 dented) was cleaned by sifting off the foreign materials. Water, at a temperature of about 160° F., was added to the cleaned corn at a rate of about 2-4% for 2-4 min. The cleaned and tempered corn was fed to a decorticator to debran and degerm the corn while cracking the corn into pieces. Each of the streams (i.e., the germ stream and the bran stream) were ground into flour on an attrition mill with at least 90% through 60M.

For pregelatinization, the mixture was then cooked on an expander (e.g., a single screw extruder). Briefly, the mixture was fed into a conditioner at about 3300 lbs/hr, and hot water was added at about 21 gal/hr. The conditioner discharge temperature was about 198° F. The material was extruded through a die at a temperature of about 295° F. The extruded product was dried to a moisture of 11.5-13.5% and cooled. The dried product was ground on a hammer-mill to a final granulation of about 75% through 60M.

### Example 7

### Accelerated Storage Experiments

Experiments were performed on the whole grain products to determine the shelf-life as well as to evaluate the effects of antioxidants (e.g., vitamins C and E) on the shelf-life of the stabilized whole grain corn flour disclosed herein (referred to as Sample C). In addition to Sample C, cones (composite samples) were analyzed. Vitamin C sodium ascorbate and vitamin E acetate were obtained in dry powder form from the Wright Group (Crowley, La.).

For accelerated storage, each flour sample was stored in a sealed Mason jug in an oven at 46-48° C. One week under such accelerated storage conditions is the equivalent of approximately 1 month of natural storage (i.e., at room temperature (˜25° C.)) based on lipid rancidity chemistry (e.g., according to studies by Gomez-Alonso et al., 2004, Euro. J. Lipid Sci. Technol., 106:369-375). A 200 g sample was taken every week for 6 weeks and kept frozen until analysis.

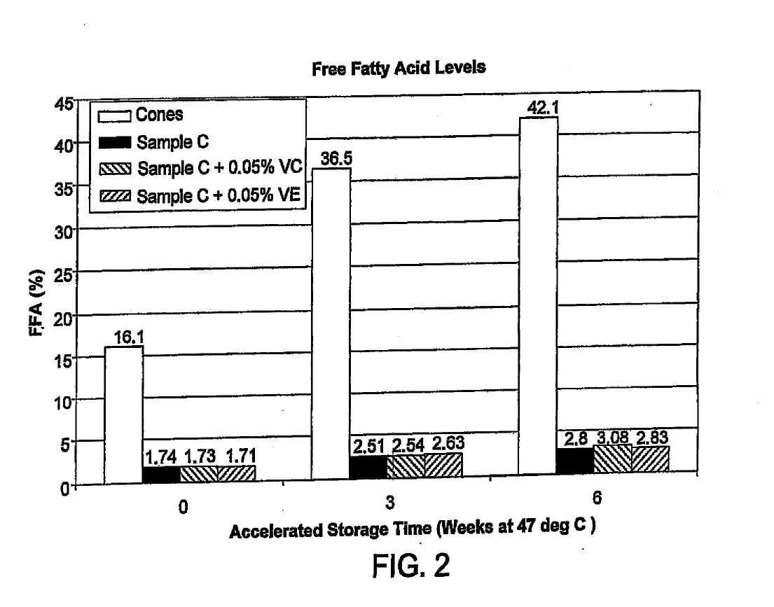

FIG. 2 shows the free fatty acid levels in the samples that underwent accelerated storage conditions. FIG. 2 shows that Sample C had significantly lower free fatty acids than cones. At the first time point (i.e., the equivalent of approximately 1 month of natural storage), the free fatty acid level in Sample C was similar to that in typical corn oil. The free fatty acid increased over storage but the level of increase was moderate, particularly considering that corn oil is prone to lipid hydrolysis. The data indicated that lipase was considerably deactivated in Sample C.

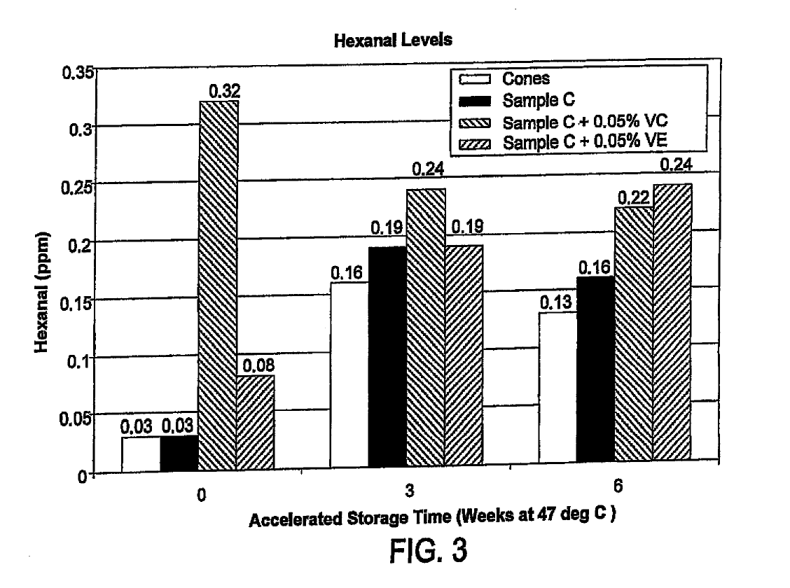

FIG. 3 shows the hexanal levels in the flour under accelerated storage conditions. At a level of 0.15 ppm of hexanal, 50% of people can detect its presence (in water) in sensory tests. Considering the complexity of corn flavor, however, levels of hexanal below 0.25 ppm are not likely to have a great negative impact on flavor. In these experiments, the cones had low levels of hexanal, which is likely a reflection of its low oil content. At the first time point (i.e., at approximately 1 month of natural storage), the hexanal content also was low in the Sample C flour alone or with Vitamin E.

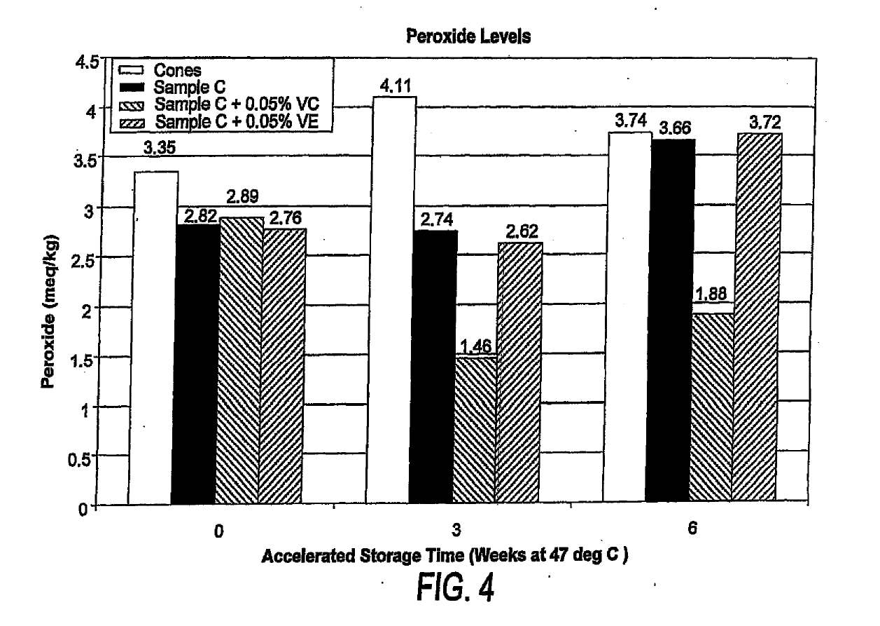

FIG. 4 shows the peroxide levels in the flour under the accelerated storage conditions. Generally, the peroxide levels were low in all the samples. A typical level of 20 meq peroxide/kg food is considered to be at the onset of the rancidity process. A level below 5 meq peroxide/kg food is considered good and free of oxidative rancidity. None of the samples reached a peroxide level of 5 meq peroxide/kg food even after 6 weeks of accelerated storage (i.e., the equivalent of approximately 6 months of natural storage).

In summary, the stabilized whole grain corn flour described herein was found to be reasonably stable in all the attributes analyzed. The estimated shelf life of such a whole grain flour is over 6 months at room temperature. Vitamins C and E in the dry powder form that was blended with the flour at 0.05% did not seem to have a significant effect on preventing oxidation or lipid hydrolysis.

### Example 8

### Evaluation of Cereals Made with High Fiber and/or Stabilized Whole Grain Flour or Pregelatinized Whole Grain Flour

Puffed cereals were made using the stabilized whole grain corn flour and/or the pregel whole grain corn flour disclosed herein in varying amounts and with varying amounts of fiber. The puffed cereal was then evaluated to determine whether or not each particular formula provided an ‘excellent source’ (ES; at least 16 g whole grains per 30 g finished cereal) or ‘good source’ (GS; at least 8 g whole grains per 30 g finished cereal) of whole grains (WG) and whether or not each particular formula provided an ‘excellent source’ (ES; at least 5 g total dietary fiber per 30 g finished cereal) or a ‘good source’ (GS; at least 2.5 g total dietary fiber per 30 g finished cereal) of fiber (F). The experiments were performed to test the effects of corn bran purity as indicated by it total dietary fiber (TDF) and its granulations on the attributes of the puffed cereal as well as to test the effects of the stabilized whole grain corn flour and pregel whole grain flour on the cereal attributes.

Materials. For corn meals, a stabilized whole grain corn flour made as described, for example, in Example 5 as well as a pregel whole grain flour made as described in Example 6 were used in the puffed cereal recipe. The whole grain flours described herein were compared to non-whole grain (de-branned and de-germed) flours and pregelatinized de-branned and be-germed flours (Cargill, Inc.). Whole oat flour was obtained from La Crosse Milling Co (Cochrane, Wis.); trisodium phosphate (TSP; N53-40) was obtained from Chemische Fabrik Budenheim. Calcium carbonate (precipitated calcium carbonate No. 410) was obtained from Specialty Minerals (New York, N.Y.). Evaporated salt (Fine Blend, Cargill, Inc.) was used in the formulas, and BatterCrisp (Cargill, Inc.) was used as the modified food starch.

Table 2 shows the various formulations used in these experiments. Formulas were designed to target the desired levels of whole grains as well as total dietary fiber levels while maintaining the desired total pregel levels.

TABLE 2
Formulas and Expected Whole Grains and Total Dietary Fiber Values
(per 30 g Serving)

| | Run | | | | | | | | |
|---|---|---|---|---|---|---|---|---|---|
| | 0 | 1 | 2 | 3 | 4 | 5 | 6 | 7 | 8 |
| Description | Control | Exp. | Exp. | Exp. | Exp. | Exp. | Exp. | Exp. | Exp. |
| | | Design | Design | Desing | Design | Design | Design | Design | Design |
| | | 1 | 2 | 3 | 4 | 5 | 6 | 7 | 8 |
| Bran Type† | None | 71-C | 71-M | 71-F | 81-C | 81-M | 81-F | 90-C | 90-M |
| Pregel:Non- | None | 3:1 | 2:1 | 1:1 | 2:1 | 1:1 | 3:1 | 1:1 | 3:1 |
| pregel | | | | | | | | | |
| Stabilized | | | | 9 | | 9 | | 9 | |
| Whole Grain | | | | | | | | | |
| Flour (%) | | | | | | | | | |
| Stabil. Whole | | 44 | 44 | 35 | 44 | 35 | 44 | 35 | 44 |
| Grain Pregel | | | | | | | | | |
| Flour (%) | | | | | | | | | |
| Cones (%) | 75.5 | 17.5 | 25.9 | 25.9 | 26.4 | 26.4 | 18 | 26.9 | 18.7 |
| Pregel (%) | | 8.4 | | | | | 8.4 | | 8.2 |
| Whole Oat | 10 | 10 | 10 | 10 | 10 | 10 | 10 | 10 | 10 |
| Flour (%) | | | | | | | | | |
| Starch (%) | 3 | 3 | 3 | 3 | 3 | 3 | 3 | 3 | 3 |
| TSP (%) | 0.1 | 0.1 | 0.1 | 0.1 | 0.1 | 0.1 | 0.1 | 0.1 | 0.1 |
| CalCarb (%) | 0.4 | 0.4 | 0.4 | 0.4 | 0.4 | 0.4 | 0.4 | 0.4 | 0.4 |
| Salt (%) | 1 | 1 | 1 | 1 | 1 | 1 | 1 | 1 | 1 |
| Bran (Fiber) | 0 | 5.6 | 5.6 | 5.6 | 5.1 | 5.1 | 5.1 | 4.6 | 4.6 |
| (%) | | | | | | | | | |
| Sugar (to be | 10 | 10 | 10 | 10 | 10 | 10 | 10 | 10 | 10 |
| coated) (%) | | | | | | | | | |
| Total | 100 | 100 | 100 | 100 | 100 | 100 | 100 | 100 | 100 |
| Whole | 3 | 16.1 | 16.1 | 16.1 | 16.1 | 16.1 | 16.1 | 16.1 | 16.1 |
| Grains/30 g | | | | | | | | | |
| Total | 0.93 | 2.81 | 2.81 | 2.81 | 2.8 | 2.8 | 2.8 | 2.81 | 2.81 |
| Dietary | | | | | | | | | |
| Fiber/30 g | | | | | | | | | |

| | Run | | | | | | |
|---|---|---|---|---|---|---|---|
| | 9 | 10 | 11 | 12 | 13 | 14 | 15 |
| Description | Exp. | No | Lower | GS | ES WG | ES | Cones + |
| | Design | Pregel | Pregel | WG | ES F | WG | Fiber |
| | 9 | | | GS F | | ES F | |
| Bran Type† | 90-F | 71-M | 71-M | 71-M | 71-M | 71-M | 71-M |
| Pregel:Non- | 2:1 | None | 1:4 | 1:4 | 1:3 | 3:2 | None |
| pregel | | | | | | | |
| Stabilized | | 44 | 44 | 17 | 44 | 24 | |
| Whole Grain | | | | | | | |
| Flour (%) | | | | | | | |
| Stabil. Whole | 44 | | | | | 20 | |
| Grain Pregel | | | | | | | |
| Flour (%) | | | | | | | |
| Cones (%) | 26.9 | 25.9 | 12 | 38.5 | | | 79.9 |
| Pregel (%) | | | 13.9 | 12 | 14.5 | 14.5 | |
| Whole Oat | 10 | 10 | 10 | 10 | 10 | 10 | 0 |
| Flour (%) | | | | | | | |
| Starch (%) | 3 | 3 | 3 | 3 | 3 | 3 | 3 |
| TSP (%) | 0.1 | 0.1 | 0.1 | 0.1 | 0.1 | 0.1 | 0.1 |
| CalCarb (%) | 0.4 | 0.4 | 0.4 | 0.4 | 0.4 | 0.4 | 0.4 |
| Salt (%) | 1 | 1 | 1 | 1 | 1 | 1 | 1 |
| Bran (Fiber) | 4.6 | 5.6 | 5.6 | 8.0 | 17.0 | 17.0 | 5.6 |
| (%) | | | | | | | |
| Sugar (to be | 10 | 10 | 10 | 10 | 10 | 10 | 10 |
| coated) (%) | | | | | | | |
| Total | 100 | 100 | 100 | 100 | 100 | 100 | 100 |
| Whole | 16.1 | 16.1 | 16.1 | 8.1 | 16.1 | 16.1 | 0 |
| Grains/30 g | | | | | | | |
| Total | 2.81 | 2.81 | 2.81 | 2.87 | 5.2 | 5.2 | 1.8 |
| Dietary | | | | | | | |
| Fiber/30 g | | | | | | | |

†the first number refers to the approximate percentage of total dietary fiber in the bran type; the letter refers to the general granulation size (C, coarse; M, medium; F, fine) of the bran.

Extrusion. Dry ingredients (22.5 kg) were blended in a ribbon blender for 5 min. The blend was fed into a Buhler twin-screw extruder (EX-3C) at a rate of 34.0-34.4 kg/hr together with water at a rate of about 6.5 kg/hr for good source (GS) of fiber samples, 5.5 kg/hr for excellent source (ES) of fiber samples, and 7.4 kg//hr for standard cones. The barrel zone temperature was 175-175-150-100° F. for Runs 0 through 9 (except Run 7) and 15, and 185-185-160-100° F. for Runs 10 through 14 and Run 7. The extruder shaft torque was between 137-162 Nm. A high torque of 191-192 Nm was also tried on Run 9 and Run 12 but no significant changes on product attributes were observed. On Run 12, water feeding rate was lowered to 4.98 kg/hr (from 6.49 kg/hr), but no significant product change was observed. The extruded puffed cereals were dried on a fluid-bed dryer (Buhler OTW 05TRR2).

Color Measurement. Color values (brightness (L), redness (a), and yellowness (b)) of intact puffed cereals were measured on a color meter (Hunter DP9000). Two measurements were made for each sample.

Strength Measurement. Cereal strength was measured on a Texture Analyzer TA-XT2 as an indicator of cereal crunchiness. Cereal samples were packed into a cylindrical void (φ 1.5″, Depth 1⅜″) in a plate (TPA). A probe (TA70, Contact φ 11/16″, Probe φ 1″) compressed the puffed cereals at a speed of 1 mm/s for a distance of 12 mm. Six measurements were made for each sample.

Cereal Flavor. Cereal flavor was ranked on a scale of 1 to 10, with 10 being the best, with full, aromatic corn flavor, typical of a puffed cereal made with conventional formulas containing no additional fiber or whole grains.

Results and Analysis. Table 3 shows the attributes of cereal made with the various whole grain and fiber formulations.

TABLE 3
Attributes of Puffed Cereal

| | Run | | | | | | | |
|---|---|---|---|---|---|---|---|---|
| | 0 | 1 | 2 | 3 | 4 | 5 | 6 | 7 |
| Description | Control | Exp. | Exp. | Exp. | Exp. | Exp. | Exp. | Exp. |
| | | Design 1 | Design 2 | Design 3 | Design 4 | Design 5 | Design 6 | Design 7 |
| Bran Type† | None | 71-C | 71-M | 71-F | 81-C | 81-M | 81-F | 90-C |
| Pregel:Non- | None | 3:1 | 2:1 | 1:1 | 2:1 | 1:1 | 3:1 | 1:1 |
| pregel | | | | | | | | |
| Moisture (%) | 2.87 | 1.84 | 2.83 | 2.16 | 2.44 | 2.16 | 2.19 | 1.7 |
| Bulk Density | 138 | 124 | 122 | 124 | 130 | 130 | 134 | 150 |
| (g/100 in³) | | | | | | | | |
| L (Brightness) | 63.25 | 58.44 | 57.92 | 57.6 | 57.7 | 57.2 | 56.7 | 58.4 |
| a (Redness) | 2.39 | 2.24 | 2.25 | 1.61 | 2.59 | 3.15 | 3.67 | 2.27 |
| b (Yellowness) | 29.52 | 25.16 | 25.13 | 25.1 | 25.1 | 24.71 | 24.5 | 25 |
| Strength (g) | 4984 | 3445 | 3313 | 2117 | 3706 | 3106 | 3613 | 3578 |
| Strength Std | 327 | 194 | 593 | 433 | 505 | 338 | 368 | 360 |
| Dev (g) | | | | | | | | |
| Corn Flavor | 10 | 9 | 9 | 9 | 9 | 9 | 9 | 9 |

| | Run | | | | | | | |
|---|---|---|---|---|---|---|---|---|
| | 8 | 9 | 10 | 11 | 12 | 13 | 14 | 15 |
| Description | Exp. | Exp. | No | Lower | GS | ES | ES | Cones + |
| | Design 8 | Design 9 | Pregel | Pregel | WG | WG | WG | Fiber |
| | | | | | GS F | ES F | ES F | |
| Bran Type† | 90-M | 90-F | 71-M | 71-M | 71-M | 71-M | 71-M | 71-M |
| Pregel:Non- | 3:1 | 2:1 | None | 1:4 | 1:4 | 1:3 | 3:2 | None |
| pregel | | | | | | | | |
| Moisture (%) | 3.07 | 2.4 | 1.93 | 1.71 | 1.98 | 1.66 | 1.51 | 1.66 |
| Bulk Density | 130 | 124 | 128 | 115 | 132 | 130 | 130 | 130 |
| (g/100 in³) | | | | | | | | |
| L (Brightness) | 58.53 | 59.26 | 57.92 | 57.43 | 58.67 | 56.9 | 57 | 61.26 |
| a (Redness) | 2.08 | 1.5 | 2.78 | 2.33 | 2.73 | 3.12 | 3.77 | 3.68 |
| b (Yellowness) | 25.7 | 25.51 | 24.08 | 24.39 | 24.89 | 21.8 | 22 | 28.38 |
| Strength (g) | 3227 | 2847 | 2564 | 2670 | 2704 | 2439 | 2955 | 3387 |
| Strength Std | 333 | 277 | 390 | 496 | 582 | 192 | 142 | 478 |
| Dev (g) | | | | | | | | |
| Corn Flavor | 9 | 9 | 9 | 9 | 9 | 7 | 7 | 10 |

†refer to Table 2 above

†, refer to Table 2 above

Bulk Density. A bulk density of around 130 g/100 in³ was targeted. All formulas were able to achieve that target reasonably well. There are additional processing adjustments that could be done to increase or decrease the expansion. On Runs 13-14, samples with excellent source levels of whole grain and fiber, the size of the cereal products was uniformly smaller than the other runs, but the bulk density and internal cell structure were comparable with the controls.

Color. Fiber type and granulations in general had no significant effect on cereal brightness and yellowness except that the samples containing the 90%-total-dietary-fiber bran type (Runs 7-9) were slightly lighter, while the samples containing approximately 81%-total-dietary-fiber bran type (Runs 4-6) were slightly darker. The biggest impact on color was total dietary fiber inclusion, not surprisingly, with higher total dietary fiber resulting in darker and less yellow cereals.

Strength. In general, a higher strength generally corresponds to a higher crunchiness and a lower strength corresponds to a lighter texture. In addition, it is known that sugar coating will change, sometimes significantly, the texture and strength of a cereal, but a change that is proportional to the amount of sugar coating would be expected.

Results from the experiments described herein indicated that strength was correlated with fiber granulations and pregel level; with coarse fiber and high pregel giving the highest strength. In terms of fiber type, samples containing the 81% total dietary fiber bran type gave the highest strength and the samples containing the 71%-total-dietary-fiber bran type gave the lowest strength.

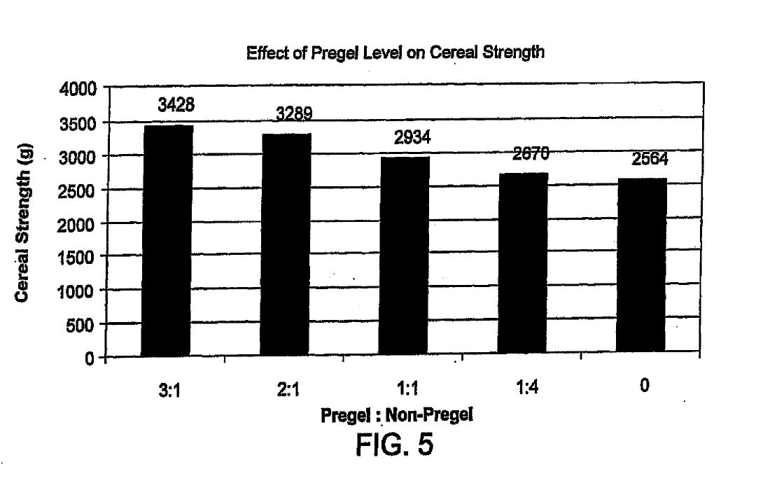

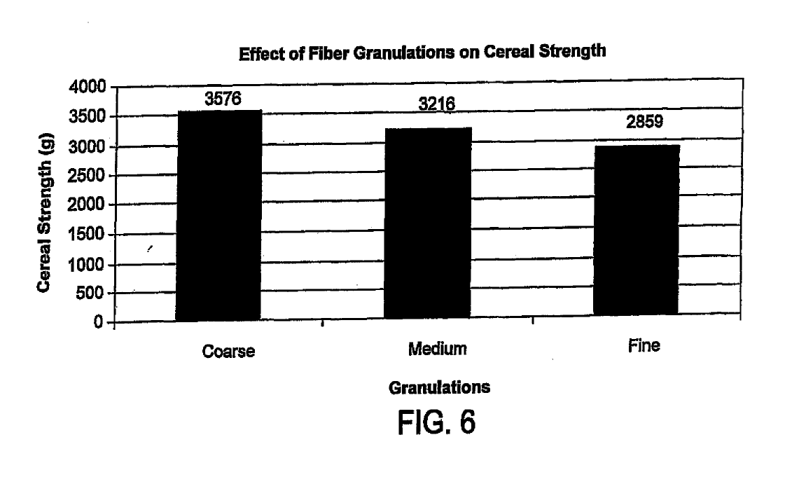

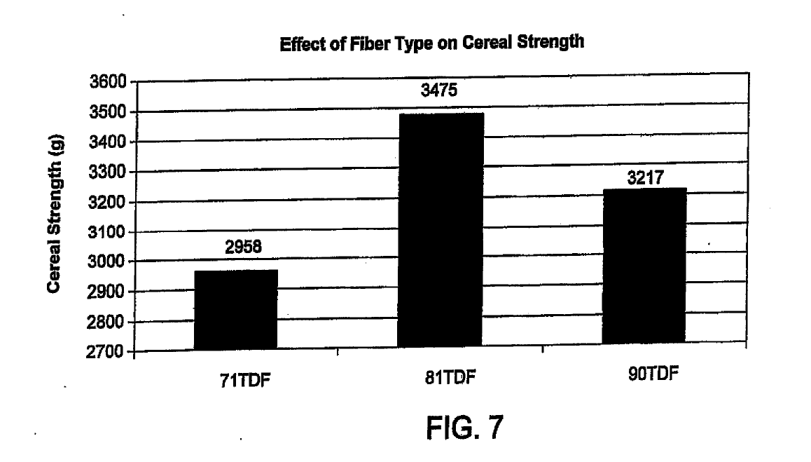

FIGS. 5, 6, and 7 depict the effects of the amount of pregel flour in the formula, the fiber granulation size (coarse, medium, and fine) and fiber type (71%, 81% or 90% total dietary fiber on a dry basis), respectively, on cereal strength. All samples were targeting an excellent source (ES) of whole grain (WO) (at least 16 g WG per 30 g cereals) and a good source (GS) of fiber (F) (at least 2.5 g total dietary fiber per 30 g cereals).

All values in the graphs except 1:4 and 0 pregel columns were based on the 9 experimental design results described in the Examples above. Generally, increasing the amount of pregel flour contributes to cereal strength probably through building a better matrix with less defects. Coarser fiber contributes to strength, probably due to its inherent physical strength of networking. The results also show that the more fiber that was in the formula, the less strength the cereal exhibited.

Corn Flavor. Corn flavor/aroma was decreased by the increasing level of fiber.

Summary. All of the experimental formulas gave good expansion and cell structure with acceptable overall eating quality. The effects of increasing fiber content included lower strength of cereal (lower crunch, lighter texture), lower brightness and less yellowness, and lower corn flavor. Generally, cereal strength (crunch) was negatively affected by fiber fineness, and pregels increased cereal strength (crunch). Pregelatinized whole grain flour has the advantage of providing strength and texture improvements while allowing the formula to have a high inclusion of whole grains.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A whole grain corn flour made by a method comprising the steps of:
providing corn germ that has been separated from non-germ corn components of whole grain corn;
heating the corn germ using direct heat for a time and at a temperature sufficient so that the corn germ is substantially free of catalase activity; and
combining the heat-treated corn germ with one or more additional heat-treated non-germ corn components to make whole grain corn flour.

2. The whole grain corn flour of claim 1, wherein the direct heat comprises direct steam.

3. The whole grain corn flour of claim 1, wherein the corn germ is heated using direct heat to a temperature in the range of from 230-280° F. and maintained within said temperature range for a time sufficient so that the corn germ is substantially free of catalase activity.

4. The whole grain corn flour of claim 3, wherein the corn germ is heated with direct steam pressurized to about 60-120 psi for about 2-15 minutes.

5. The whole grain corn flour of claim 3, wherein the corn germ is heated with forced air for about 5-25 minutes.

6. The method of claim 1, further comprising the step of grinding the heat-treated germ to a desired granulation profile.

7. The whole grain corn flour of claim 1, further comprising the step of, after heating the corn germ using direct heat, heating the corn germ using indirect heat to a temperature in the range of from 200-230° F. and maintained within said temperature range for about 10-30 minutes.

8. The whole grain corn flour of claim 7, further comprising the step of, after indirect heating, grinding the heat-treated germ to a desired granulation profile.

9. The whole grain corn flour of claim 7, wherein the indirect heat is provided via a steam jacketed conveyor.

10. The whole grain corn flour of claim 1, wherein the non-germ corn components comprise endosperm, bran, and tipcap.

11. The whole grain corn flour of claim 1, further comprising:
providing corn bran that has been separated from non-bran corn components of whole grain corn;
heating the corn bran; and
combining the heat-treated corn germ and heat-treated corn bran with one or more additional corn components to make whole grain corn flour.

12. The whole grain corn flour of claim 11, wherein the heat-treated corn bran is ground to a granulation of at least 80% through a 60 mesh screen.

13. The whole grain corn flour of claim 1, further comprising:
providing endosperm that has been separated from non-endosperm corn components of whole grain corn; and
combining the heat-treated corn germ, heat-treated corn bran, and endosperm to make whole grain corn flour.

14. The whole grain flour of claim 13, wherein the endosperm is ground to a granulation of at least 90% through a 60 mesh screen.

15. The whole grain corn flour of claim 1, further comprising the steps of:
grinding the combined heat-treated corn germ and heat-treated non-germ corn components to form a mixture.

16. The whole grain corn flour of claim 1, further comprising the steps of:
grinding the heat-treated germ;
grinding the heat-treated non-germ corn components; and
combining the ground heat-treated corn germ with the ground heat-treated non-germ corn components.

17. The whole grain flour of claim 1, wherein the whole grain corn flour has a Rapid Viscosity Analyzer (RVA) peak viscosity of less than about 600 cps at about 35% dry basis while mixed at 50° C., and RVA peak viscosity of less than about 4000 cps at about 12.5% dry basis while heated to and held at about 95° C.

18. The whole grain flour of claim 1, wherein the whole grain corn flour has a Rapid Viscosity Analyzer (RVA) peak viscosity of less than about 300 cps at about 35% dry basis while mixed at 50° C., and RVA peak viscosity of less than about 2000 cps at about 12.5% dry basis while heated to and held at about 95° C.
